(19) United States
(12) Patent Application Publication
(10) Pub. No.: US 2003/0081917 A1
(43) Pub. Date: May 1, 2003

(54) Method and apparatus for fiber optic monitoring of downhole power and communication conduits

(76) Inventor: Terry Bussear, Round Rock, TX (US)

Correspondence Address: CANTOR COLBURN LLP, 55 Griffin Road South, Bloomfield, CT, 06002, US

(21) Appl. No.: 10/283,501

(22) Filed: Oct. 29, 2002

Related U.S. Application Data
(60) Provisional application No. 60/335,423, filed on Oct. 31, 2001.

(51) Int. Cl. G02B 6/44

(52) U.S. Cl. 385/101; 385/102; 385/12

(57) ABSTRACT

A method and apparatus for fiber optic monitoring of downhole power and/or communication conduits employs optic fibers near such conduits or even within an encapsulation of said conduits to monitor integrity thereof.

### CROSS-REFERENCE TO RELATED APPLICATIONS

This application claims the benefit of an earlier filing date from U.S. Serial No. 60/335,423 filed Oct. 31, 2001, the entire contents of which is incorporated herein by reference.

### BACKGROUND

Modem well construction operation and maintenance requires that power and communication pathways be extended over long distances in the downhole environment. Necessarily then, the conduits employed to provide such pathways are subjected to significant deleterious effects of the downhole environment. Conduits suffer impacts and abrasion, during run-in, and can be damaged or rendered inoperable thereby. Because of the distances involved, inter alia, a power or communication conduit which has become inoperative might not be immediately apparent at the surface of the well. This can result in costly delays of production if power or signals are not reaching the intended targets.

### SUMMARY

A method for monitoring the power and/or signal conduits whether in copper, optic fiber, or any other type of conductor, in a well and an apparatus therefore employs optic fiber(s) to gain information regarding condition of the conduits. Changes in light conductivity and/or reflectivity along a fiber are indicative of strain or stress in the optic fiber. By measuring such changes, one can extrapolate the condition of the power or communication pathway.

An apparatus is disclosed including structure by which the method can be performed.

### BRIEF DESCRIPTION OF THE DRAWINGS

Referring now to the drawings wherein like elements are numbered alike in the several FIGURES:

FIG. 1 is a perspective cross-section view of a power or communication conduit having optic fibers embedded in an encapsulation matrix thereof;

FIG. 2 is a schematic cross-sectional view of a portion of a wellbore having a restriction therein and illustrating a cross-coupling clamp-type protector; and

FIG. 3 is an alternate arrangement wherein an optic fiber is proximate connections to determine the state the connections are in.

### DETAILED DESCRIPTION

Each of the iterations of the monitoring concept disclosed herein is related in that they rely upon the changing optical properties of optical fibers when the fibers are subjected to strain, stress, heat, breakage, etc. By measuring the degradation or change of light transmissivity, backreflection and/or measuring the reflectivity and by employing elapsed time as an additional factor in the measurement, a very accurate construction of the conditions affecting that fiber can be made. The conditions actually affecting the power or communications conductors(s) with which the fiber is associated are likely to be very similar. In order to further enhance accuracy of the construction of conditions, additional fibers may be employed each being individually queried and then an average may be taken among the fibers such that representation of strain, stress, heat, breakage, etc. can be derived.

Reflectivity and transmissivity are related to H+loading and excessive thermal exposure.

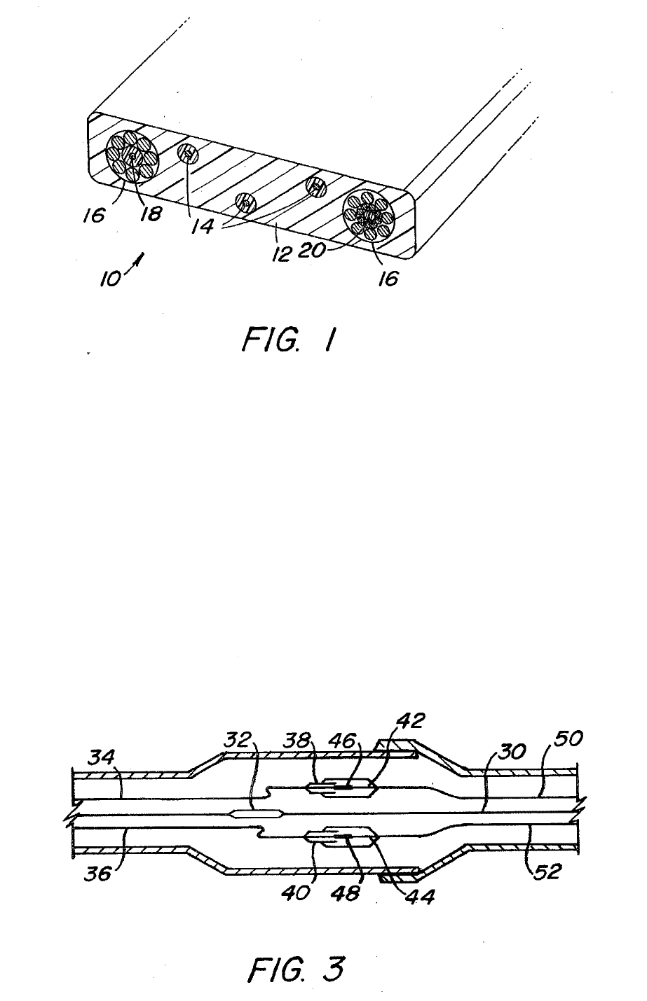

Backreflection is related to integrity of connections within the fiber channel. Referring to FIG. 1, a power/and or communications conduit is illustrated. In the vernacular, such a conduit illustrated is often referred to as an “umbilical”. It will be appreciated that an umbilical is but one embodiment of the method and apparatus described herein and that the disclosure hereof applies to any conduit for power or communications in the downhole environment. The conduit 10 comprises an encapsulant material 12 which exhibits structural integrity and abrasion resistance to the extent necessary to ensure its usefulness in the downhole environment. Material 12 may be a plastic material and may be polymeric. In order to enhance the manufacturability of conduit 10 the material may be extrudable or moldable (although other means of manufacture are also contemplated). Abrasion resistance and crush resistance are provided to conductors encapsulated therein.

In the embodiment illustrated in FIG. 1, three sensing fibers 14 are employed. The illustration further includes crush resistant cable members 16 which each comprise a plurality of individual lines twisted into each cable member 16. These comprise stiffening material such as metal, steel in solid form or twisted form, braided steel wool, braided mineral wool, fiberglass, polyaramid fibers, carbon fibers, etc. and combinations including at least one of the foregoing as well as other materials suitable to add strength to the umbilical. In this embodiment one of the cable members 16 also includes a centrally disposed and protected insulated electrical conductor 18 while the other cable member 16 includes a fiber optic conductor 20 protected therein. It will be understood that FIG. 1 is illustrative only and that fewer or other conductors or sensing fibers may be substituted, providing an elongated sensing member is in contact with the encapsulant which itself is in contact with a conductor.

Each of the one or more elongated sensing members which may be optic fibers are measured for light conductivity, transmissivity, etc. as stated hereinbefore as a measure of what strain or stress the conduit 10 is under at any given time or is experiencing over time. As noted above, change in measured light properties provide a calculatable indication of condition of the conduit 10 downhole.

In another embodiment, a single optic fiber is employed as the conductor and is measured to monitor its own condition using the same parameters discussed above.

By monitoring periodically or continuously, as desired, an accurate picture of the condition of the conduit can be generated. In addition, and particularly importantly, upon installation of a tool, the operator of the well will know if a conduit has been compromised beyond usability. This is early notification that the device should be pulled. Where in the prior art it would not be known until the tool was installed, tested and in service, the device and method disclosed herein provides notification as early as an occurrence is measurable and so avoids wasted time or loss of the usability of the system in the near future. Time Domain Reflectometry could then be used to determine the location the fault and save time during the repair operations.

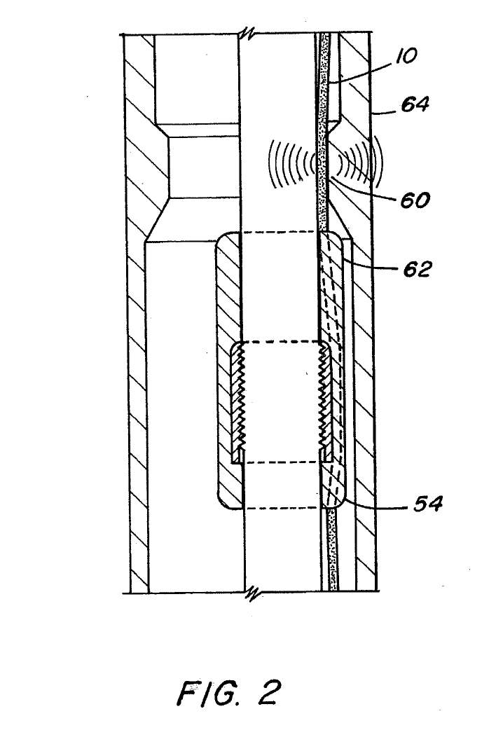

Related to FIG. 1 is FIG. 2 wherein the optic fiber sensing arrangement and method described is particularly useful. FIG. 2 illustrates schematically a cross-coupling clamp-type protector 62 which is a commercially available device intended to protect a conduit 10 at the location of a tubing coupling 54. As is known to one of skill in the art, were the protector 62 to be omitted, significant impact would be visited on conduit 10 because of the large OD at the coupling 54. A restriction 60 in the wellbore can be caused by any number of things, the exact cause not being germane to the functioning of the method and apparatus herein described. What is important to note is that while in a system having multiple cross-coupling clamps, a conduit 10 is spaced from borehole wall 64, when the coupling protectors 62 straddle a restriction 60 (only one of the couplings shown), the restriction may contact conduit 10. Conduit 10 is at that point subject to significant abrasion and compressive loading. As one of skill in the art appreciates this occurs primarily during run-in. The method and apparatus hereof provides information to the operator regarding condition of conduit 10 including any conditions that will require its removal from the well and replacement. By having knowledge of a significantly damaged condition during the run-in process, the additional time and effort of finishing the process, to only then discover the problem, is avoided.

The apparatus and method described is also useful in a related way to determine when the proper radial clamping force is created in a cross-coupling clamp-type protector by monitoring strain in the fiber(s) 14. Additionally, whether or not proper clamping force has been maintained can be monitored during deployment and throughout the life of the tool or the well. Any change in clamping force is apparent including loss of the clamp altogether. The method and apparatus work in this connection identically to the way in which they have been described above. What is done with the data is slightly different. In this embodiment a specific amount of strain is a target. Thus, the finding of strain in the optic fiber is not a warning sign, but rather is an indicator relative to which the installation strain caused by the clamp may be adjusted until the indicator indicates a selected strain on the fiber. The proper strain having been reached, the protector is properly installed. After installation, a change in the selected strain indicates a loosening or loss of the clamp.

In another embodiment, and referring to FIG. 3, an optic fiber alone or with an optic sensor 32 is employed to monitor the condition of electrical connectors at a splice location. As stated hereinabove, temperature affects light travel through optic fibers. By monitoring the change, heat to which the fiber is subjected can be evaluated. With age, electrical connectors can develop corrosion. As corrosion affects the interface between two or more conductors, heat is generated. The more heat generated, generally the more corrosion is present. The heat is due to resistance caused by the corrosion. The amount of heat sensed either at a particular splice or averaged over a number of splices is easily correlated to the degree of corrosion which can then be used to extrapolate expected balance or life span of the connection of plurality of connections. Other optical sensors may also be employed to monitor other conditions that may occur at the connector, alone or in addition to monitoring the temperature change. Strain, stress, fluid ingress, etc may be monitored.

In the illustrated embodiment of FIG. 3, conductors 34 and 36 appearing at the left hand side of the illustration have any type of conventional terminus 38, 40 which connects to connectors 42, 44 at interface 46, 48. These connectors operably connect conductors 34, 36 to 50, 52 (right hand side). Since connections are commonplace in the wellbore the ability to monitor temperature thereat provides valuable time to take desired action which may be to simply produce the well until failure or possibly to provide time necessary to order repair parts or schedule maintenance. Repair parts often will not be on hand and availability of equipment and personnel to perform repairs may not be readily available. With the device and method disclosed herein there is time to obtain replacement parts or make determinations regarding well life versus cost of repair, etc.

While preferred embodiments have been shown and described, various modifications and substitutions may be made thereto without departing from the spirit and scope of the invention. Accordingly, it is to be understood that the present invention has been described by way of illustration and not limitation.

1. A communications or power conduit for a wellbore comprising:
an encapsulation material;
at least one communication or power conductor embedded in the encapsulation material; and
at least one optic fiber embedded in the encapsulation material.

2. A communications or power conduit for a wellbore as claimed in claim 1 wherein said encapsulation material is a polymeric material.

3. A communications or power conduit for a wellbore as claimed in claim 1 wherein said encapsulation material is abrasion resistant.

4. A communications or power conduit for a wellbore as claimed in claim 1 wherein said conduit further includes at least one reinforcing member.

5. A communications or power conduit for a wellbore as claimed in claim 4 wherein said at least one reinforcing member further includes a conductor.

6. A communications or power conduit for a wellbore as claimed in claim 4 wherein said at least one reinforcing member is a cable formed of twisted stiff material.

7. A communications or power conduit for a wellbore as claimed in claim 6 wherein said stiff material is metal.

8. A communications or power conduit for a wellbore as claimed in claim 6 wherein said stiff material is polyaramid fiber.

9. A communications or power conduit for a wellbore as claimed in claim 6 wherein said stiff material is fiberglass.

10. A communications or power conduit for a wellbore as claimed in claim 6 wherein said stiff material is carbon fiber.

11. A communications or power conduit interface for a wellbore comprising:
at least one conductor and conductor connector; and
at least one optic fiber located proximate said conductor connector to monitor condition of the conductor connector.

12. A communications or power conduit interface for a wellbore as claimed in claim 11 wherein said fiber further includes an optical temperature sensor.

13. A communications or power conduit interface for a wellbore as claimed in claim 11 wherein said fiber further includes a strain sensor.

14. A communications or power conduit interface for a wellbore as claimed in claim 11 wherein said fiber further includes a chemical sensor.

15. A communications or power conduit for a wellbore as claimed in claim 12 wherein said sensor is disposed proximate said conductor to monitor temperature thereof.

16. A communications or power conduit for a wellbore as claimed in claim 13 wherein said sensor is disposed proximate said conductor to monitor stress thereof.

17. A communications or power conduit for a wellbore as claimed in claim 14 wherein said sensor is disposed proximate said conductor to monitor fluid thereof.
